(19) United States
(12) Patent Application Publication
(10) Pub. No.: US 2010/0064215 A1
(43) Pub. Date: Mar. 11, 2010

(54) SYSTEM AND METHOD FOR SCREEN RECORDING

(76) Inventors: Leon PORTMAN, Rishon Lezion (IL); Nir ZIGLER, Netanya (IL); Oren WEISS, Karkur (IL); Dan HADARI, Hod Hasharon (IL); Itay GRUSHIKA, Shoham (IL)

Correspondence Address: Pearl Cohen Zedek Latzer, LLP, 1500 Broadway, 12th Floor, New York, NY, 10036, US

(21) Appl. No.: 12/207,518

(22) Filed: Sep. 10, 2008

(51) Int. Cl. G06F 3/00

(52) U.S. Cl. 715/704

(57) ABSTRACT

A system and method for producing a usable stream of display data from an updated state information and a currently received stream of display data. State information may be extracted from a stream of display data and an updated state information may be maintained. Updated state information and a stream of display data may be used to produce a usable stream of display data.

### BACKGROUND

The terms screen recording or display recording as used by the industry refer to the capturing and recording of information rendering on a display of a computing device. Screen recording enables replaying sessions, user interactions, applications output and/or other events as reflected by a display of a computing device. Screen recording is widely used in industries such as call and/or contact centers. For example, screen recording may be used by such facilities to produce tutorial sessions, track employees' activities, provide input to risk and/or quality management applications or to obtain documentation and/or proof of events.

Current implementations of screen recording in interaction-related environments use a screen recording agent installed on a remote application server. Such screen recording agent may record sessions associated with computing devices, for example, agents' work stations or terminals. The problem with such implementation is the negative effect on the scalability of the remote application server and the increase of administrative cost.

Other existing implementations of screen recording employ a screen recording agent installed on work stations, for example, agents' work stations in a contact center. The problem with such implementation is that with the move of the industry from work stations to thin clients or terminals, installing of software may no longer be feasible.

There is a need in the industry for a screen recording solution that will enable screen recording of sessions associated with devices such as thin clients and/or terminals and also maintain the scalability of remote application servers.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a high-level block diagram of an exemplary screen recording system according to embodiments of the present invention;

FIG. 2 is a high-level block diagram of an exemplary server according to embodiments of the present invention;

FIG. 3 is a high-level block diagram of an exemplary client computing device according to embodiments of the present invention;

FIG. 4 is a high-level block diagram of an exemplary monitoring computing device according to embodiments of the present invention; and

FIG. 5 is a flowchart of an exemplary method of streaming display information according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed at the same point in time.

Although embodiments of the invention are not limited in this regard, the terms “screen recording” and “display recording” should be expansively and broadly construed to include any form of recording of rendering of information on a display of a computing device. For example, display and/or screen recording may refer to the recording of displayed graphical information, displayed textual information, mouse moves, a keyboard's key strokes and/or any other information displayed on a display of a computing device. Other events that may be captured and recorded by screen recording may be a turning ON or OFF of a display, a change of resolution, e.g., number of pixels used for displaying information on the display and/or any applicable rendering or other events associated with a display of a computing device.

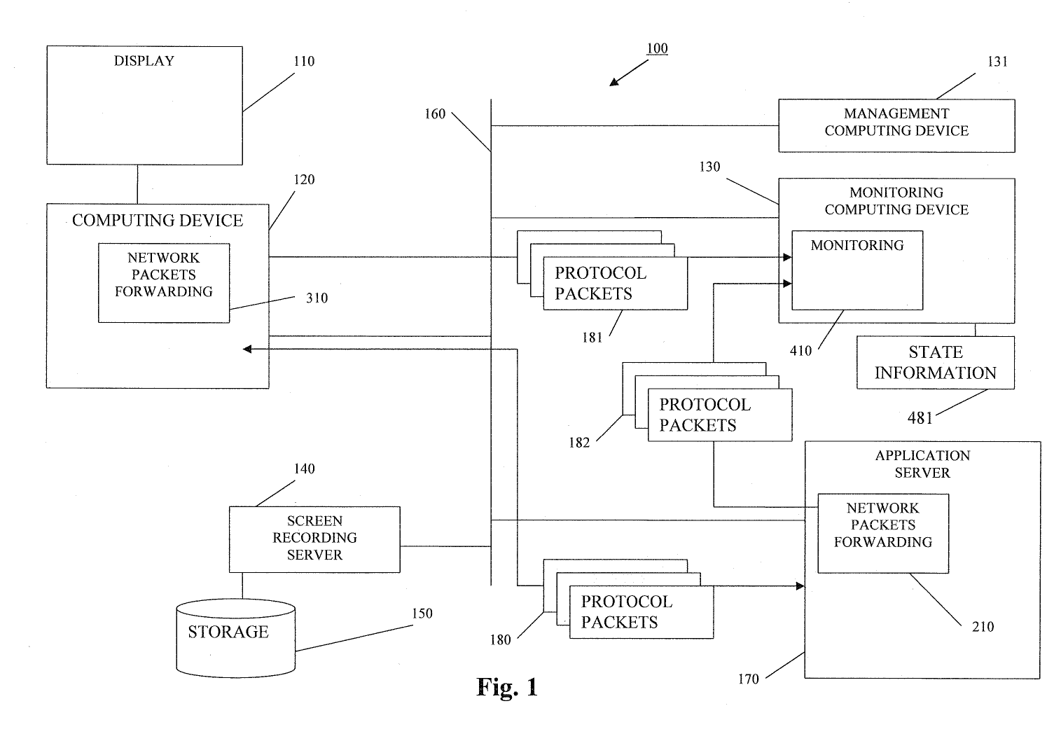

Reference is made to FIG. 1, showing a high-level block diagram of an exemplary screen recording and/or streaming system 100 according to embodiments of the present invention. System 100 may include a display 110, a computing device 120 coupled to display 110, a monitoring unit 130, a management unit 131, an application server 170 and a screen recording unit 140 operatively coupled to storage 150, all coupled to a communication network 160. According to embodiments of the invention, units 120, 130, 131 and 170 may be any applicable computing devices and may include or may be, for example, a personal computer, a desktop computer, a mobile computer, a laptop computer, a notebook computer, a terminal, a workstation, a server computer, a tablet computer or any other suitable computing device. The terms “computing device”, “computer” and “unit” as used hereinafter may refer to any applicable computing device such a work station, server or terminal and may be used interchangeably hereinafter.

According to embodiments of the present invention, units 120, 130, 131 and 170 may include components such as, but not limited to, a plurality of central processing units (CPU) or any other suitable multi-purpose or specific processors or controllers, a plurality of input units, a plurality of output units, a plurality of memory units, and a plurality of storage units. Units 120, 130, 131 and server 170 may additionally include any other suitable hardware, software and/or firmware components.

According to embodiments of the present invention, network 160 may be, may comprise, or may be part of a private IP network, the internet, an integrated services digital network (ISDN), a set of frame relay connections, a public or private data network, a local area network (LAN), a wide area network (WAN), a wireline or wireless network, a local, regional, or global communication network, an enterprise intranet, any combination of the preceding and/or any other suitable communication infrastructure. It will be recognized that embodiments of the invention are not limited by the nature, type or other aspects of network 160.

According to embodiments of the present invention, display 110 may be any suitable display device, unit or system and may be operatively connected to computing device 120. It will be noted that although a single exemplary display 110 is shown, according to embodiments of the invention, device 120 may be operatively connected to a number of such displays and, according to embodiments of the invention, screen or display streaming and/or recording may capture, stream and/or record displayed information and/or other events associated with all display units attached to a computing device such as device 120. It will be recognized that embodiments of the invention are not limited by the nature, type or other aspects of display 110.

According to embodiments of the present invention, screen recording unit 140 may be a dedicated recording device or system comprising dedicated hardware, firmware and/or software or it may be a computing device attached to a suitable storage device or system. Screen recording unit 140 may comprise or may be operatively connected to one or more storage devices such as storage 150. Storage 150 may include, for example, a hard disk drive, a tape drive, a floppy disk drive, a Compact Disk (CD) drive, a CD-Recordable (CD-R) drive, or any other suitable removable and/or fixed storage devices or units. Alternatively or additionally, storage 150 may be or may comprise large storage such as a redundant array of inexpensive drives (RAID) or other large storage capacity devices and/or sub-systems. It will be recognized that embodiments of the invention are not limited by the nature, type or other aspects of storage 150.

According to embodiments of the present invention, application server 170 may be a server in a contact or call center running applications on behalf of a human agent operating computing device 120. According to embodiments of the present invention, server 170 may function as a remote application server and may support environments such as virtual desktop and/or remote computing environments. Server 170 may further concurrently run a number of operating systems, e.g., Windows™, Linux and/or Mac OS™ possibly by supporting virtual machine technology.

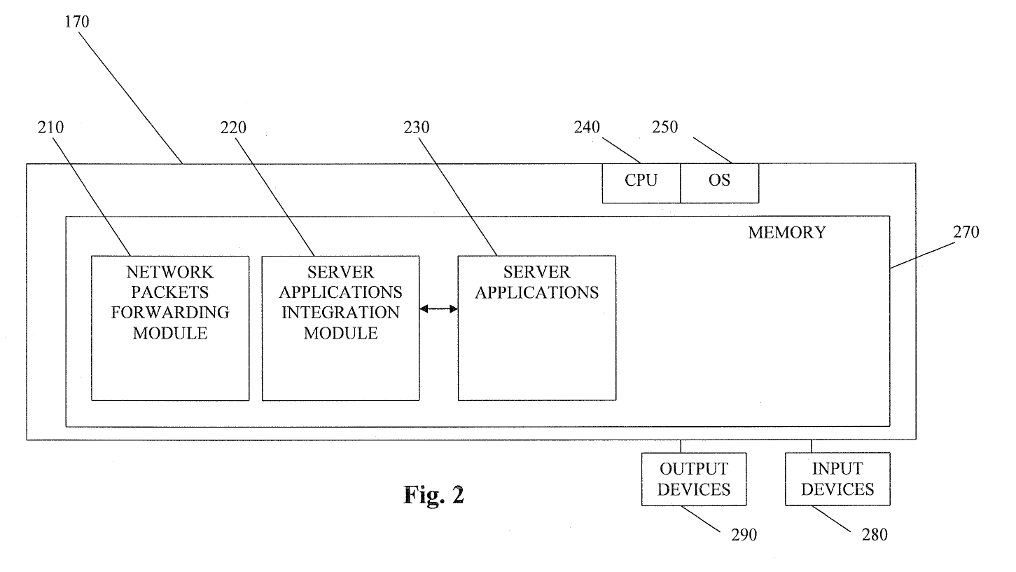

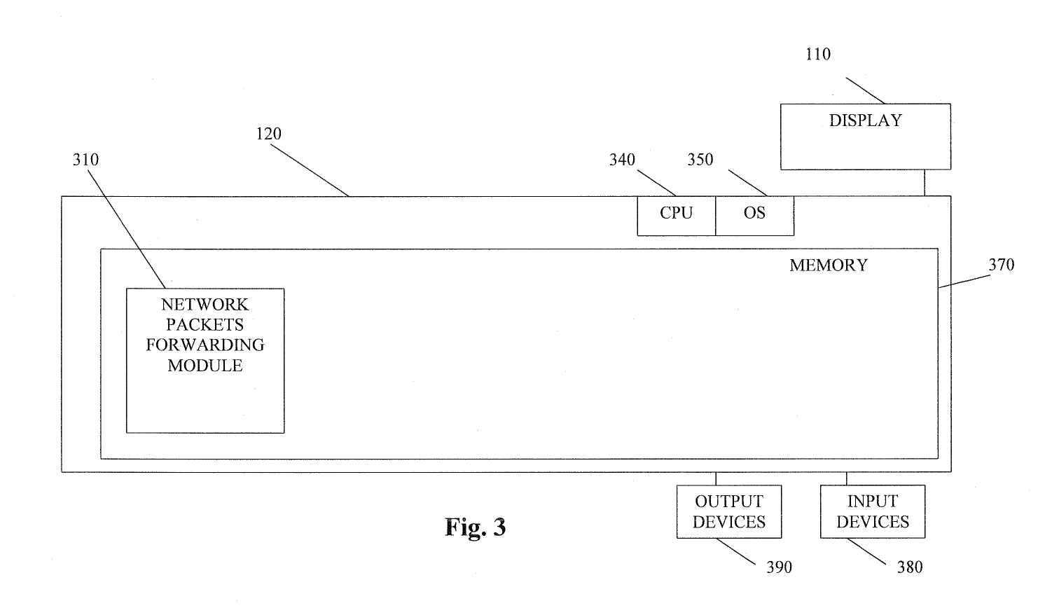

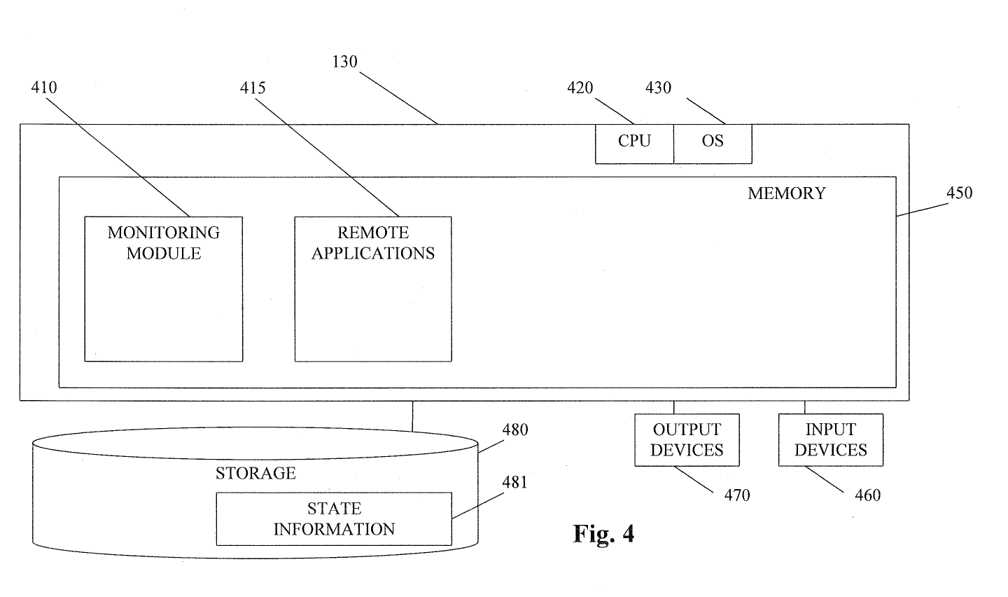

According to embodiments of the present invention, monitoring module 410 may obtain protocol packets by ways other than described above. For example, a router on network 160 may intercept protocol packets and forward such packets to module 410. Ways by which forwarding modules 310 and 210 are further described with reference to FIG. 2 and FIG. 3 respectively. Other methods for causing unit 120 to produce protocol packets and capturing such packets, for example by executing a remote application are also described in further details with reference to FIG. 4.

According to embodiments of the present invention and as shown by the double headed arrow connecting unit 120 and server 170, a session may be established between unit 120 and server 170. For example, a remote desktop session may be established between unit 120 that may be a thin client or terminal and server 170 that may be a remote application server. Such session may comprise exchanging protocol packets as shown by 180 between unit 120 and server 170. For example, protocol packets 180 may be Microsoft® remote desktop protocol (RDP) packets that may be exchanged as part of the session. Such packets may contain display information, for example, rendering information that may be used to record and/or replay display 110 may be contained in such packets. According to embodiments of the invention, such packets may further be used to extract state information of the relevant display, for example, cached glyphs, bitmaps, compression or encryption keys and/or certificates, or any other applicable information may extracted, stored and subsequently used for recording and/or providing a real-time replay of a display.

According to embodiments of the present invention, unit 120 may comprise a network forwarding module 300. According to embodiments of the present invention, module 310 may capture protocol packets received by or originating from unit 120. According to embodiments of the present invention, monitoring unit 130 may comprise a monitoring module 410. According to embodiments of the present invention, module 410 may receive or otherwise obtain protocol packets. Module 410 may further extract information from such received packets and may further compute, derive and maintain state and/or context information related to display 110. For example, information extracted or otherwise obtained by module 410 based on received protocol packets may be any display state or context information such as cached glyphs and parameters, e.g., glyphs identification parameters, encryption or compression parameters, e.g., encryption keys and/or certificates and information associating the session with which the packets are associated with a source and destination device, e.g., internet protocol (IP) addresses, telephone numbers etc.

According to embodiments of the present invention, forwarding module 310 may forward captured or otherwise obtained packets to monitoring module 410 where such packets may be used as described. According to embodiments of the present invention, monitoring module 410 may obtain or receive protocol packets from a variety of sources. For example, server 170 may comprise forwarding module 210 that may be similar to forwarding module 310. Accordingly, forwarding module 210 may forward protocol packets to monitoring module 410. Such packets may be obtain by integration with applications executed on server 170 or by obtaining such packets at lower levels, e.g., at a network interface card and/or driver level as described with further details with reference to FIG. 2.

According to embodiments of the present invention and as shown by 481, state information may be maintained by module 410. According to embodiments of the present invention, such information may be stored on a storage device operatively connected to monitoring unit 130. According to embodiments of the present invention, upon an applicable event, for example, a request to commence a recording or commence a real-time replay of display 110 monitoring module 410 may send or otherwise provide state information 481 to the relevant device or application. For example, upon receiving a command to start a recording of display 110, module 410 may send state information 481 to screen recording server 140.

According to embodiments of the present invention, screen recording server 140 may use received state information 481 to perform and/or produce an in-context recording of display 110. According to embodiments of the present invention, screen recording server 140 may use received state information to interpret a display stream received from display 110. For example, a display stream received from display 110 may contain information related to cached glyphs, such information may be useless unless the relevant cached glyphs are available or can be accessed. According to embodiments of the present invention, screen recording server 140 may use received state information 481 to access such cached glyphs and/or any other applicable information or parameters that may be required in order to interpret a display stream or otherwise use a display stream to produce a usable stream of display data and/or perform a usable recording.

According to embodiments of the present invention, other ways of using state information 481 may be possible and/or applicable. For example, upon detecting an event causing a real-time replay of display 110 on a display connected to unit 130, monitoring module 410 may send updated state information 481 to unit 130 where such information may be used in ways similar to those described with reference to screen recording server 140. According to embodiments of the present invention, provided with state information 481, an application may use an existing, on going display stream from display 110 in order to instantly commence a real-time replay or recording of display 110. According to embodiments of the present invention, information contained in provided state information 481 may enable tapping into an already in progress display stream and use such tapped or intercepted stream to produce a usable screen recording or provide an adequate real-time replay of display 110 on a remote display, e.g., a display connected to unit 131.

Reference is now made to FIG. 2 showing a high level block diagram of exemplary components of server 170 according to embodiments of the invention. According to embodiments of the invention, server 170 may comprise a central processing unit (CPU) 240 that may execute programs or applications and an operating system (OS) 250 under which programs and/or applications executed by CPU may run. Server 170 may further comprise a memory 270 on which executable code and associated parameters may be stored. Server 170 may further comprise input devices 280, such as a keyboard, a mouse or any other applicable input devices. Server 170 may comprise output devices 290 that may be a display, speakers or any other applicable output devices. According to embodiments of the invention, input devices 280 and/or output devices 290 may also be devices such as a network interface card (NIC), a universal serial bus (USB) interface module or any other devices enabling server 170 to communicate or interact with other computing devices and/or with a human operating server 170.

According to embodiments of the invention, one or more server applications 230 may be stored on memory 270 and may further be executed by server 170. Applications 230 may be, for example, remote computing applications and/or virtual desktop applications. As known in the art, such applications may utilize various protocols for communicating display and other information between server 170 and client computing devices, e.g., computing device 120. For example, such protocols may be Microsoft® remote desktop protocol (RDP), or Citrix® independent computing architecture (ICA) protocol. According to embodiments of the invention, server 170 may comprise a server applications integration module 220. Module 220 may be configured to interact with some of applications 230 and thus receive or otherwise obtain communication protocol data. For example, module 220 may interact with a remote desktop application and receive from such application RDP packets destined for and/or received from a computing device such as computing device 120.

According to embodiments of the invention, server 170 may comprise a network packets forwarding module 210. According to embodiments of the invention, module 210 may forward protocol data packets to one or more preconfigured remote computing devices over a network connecting server 170 and such remote computing devices. For example, module 210 may forward RDP packets exchanged between server 170 and computing device 120 to monitoring unit 130 and/or screen recording unit 140. According to embodiments of the invention, such protocol packets may be received by applications 230 from remote computing devices or they may be protocol packets compiled by one of applications 230 in order to be communicated to a remote computing device, such as computing device 120.

Alternatively, module 210 may obtain protocol packets from lower levels. For example, module 210 may be configured to obtain protocol packets at a network interface card (NIC) level. According to embodiments of the invention, module 210 may be configured to interact with a NIC driver and receive ingress and/or egress packets. For example, module 210 may receive from a NIC driver any RDP or ICA protocol packets either sent or received by the associated NIC. It should be noted that RDP and ICA are referred to herein as exemplary protocols for communicating screen or display information. Embodiments of the invention are not limited in this respect and other protocols may be used and/or supported.

According to some embodiments of the invention, computing device 120 may be a work station, a thin or lean client computer or it may be a terminal device. A thin client or terminal may be a computing device with limited or reduced computing and storage resources and/or capabilities. For example, a thin client computer may be diskless, and may rely on a remote server such as server 170 in order to operate. For example, computing device 120 may download an operating system and application from server 170 and run them. Computing device 120 may be capable of running a specific, possibly single application and possibly communicate over a computer network using a specific protocol such as RDP.

For example, computing device 120 may be a thin client computer used in a contact center and may serve a human agent as an interface to a server, e.g., server 170, running required applications. Such thin client may, in addition to being able to communicate over a network, e.g., network 160, be only capable of running a single application, for example, a web browsing application. In such scenario, applications are executed on one or more servers, e.g., server 170, and the thin client computer, e.g. computing device 120, is primarily used as an interface tool. As such, it enables a user, e.g., an agent in a contact center, to provide input, e.g., select items in a web page or check boxes appearing on the display. Computing device 120 may further communicate the input to a server and may also provide the agent with output from an application such as one of server applications 230 executed on server 170.

Reference is now made to FIG. 3 showing a high level block diagram of exemplary components of computing device 120 according to embodiments of the invention. According to embodiments of the invention and as shown by 340, computing device 120 may comprise a central processing unit (CPU) that may execute programs or applications. According to embodiments of the invention and as shown by 350, computing device 120 may comprise an operating system (OS) under which programs and/or applications executed by CPU may run. According to embodiments of the invention and as shown by 370, computing device 120 may comprise a memory on which executable code and associated parameters may be stored. Computing device 120 may further comprise input devices 380. Such input devices may be a keyboard, a mouse or any other applicable input devices. Computing device 120 may comprise output devices 390 that may be a display, speakers or any other applicable output devices. According to embodiments of the invention, input devices 380 and/or output devices 390 may also be devices such as a network interface card (NIC), a universal serial bus (USB) interface module or any other devices enabling computing device 120 to communicate or interact with other computing devices and/or a human operating computing device 120. According to other embodiments of the invention and as shown by 110, computing device 120 may be connected to a display. As noted above, although a single display 110 is shown, embodiments of the invention are applicable to any number of displays connected to a computing device.

According to other embodiments of the invention and as shown by 310, computing device 120 may comprise a network packets forwarding module. According to embodiments of the invention, module 310 may forward protocol data packets to one or more preconfigured remote computing devices over a network connecting computing device 120 and such remote computing devices. For example, module 310 may forward RDP packets exchanged between server 170 and computing device 120 to monitoring unit 130, screen recording server 140 or both.

According to embodiments of the invention, module 310 may obtain protocol packets from any applicable module. For example, module 310 may be configured to obtain protocol packets at a network interface card (NIC) level. According to embodiments of the invention, module 310 may be configured to interact with a NIC driver and receive ingress and/or egress packets. For example, module 310 may receive from a NIC driver RDP or ICA protocol packets either sent or received by the associated NIC. It will be noted that embodiments of the invention are not limited by the type of protocol packets thus obtained, other protocols may be used and/or supported without departing from the scope of the present invention.

According to other embodiments of the invention, any display information displayed on display 110 may be encapsulated in protocol packets such as RDP packets and may be exchanged between computing device 120 and server 170. For example, if remote desktop is used by computing device 120 in conjunction with server 170. According to other embodiments of the invention, module 310 may capture such protocol packets and send such captured packets to monitoring unit 130 and/or screen recording server 140.

Reference is now made to FIG. 4 showing a high level block diagram of exemplary components of monitoring unit 130 according to embodiments of the invention. According to embodiments of the invention and as shown by 420, monitoring unit 130 may comprise a central processing unit (CPU) that may execute programs or applications. According to embodiments of the invention and as shown by 430, monitoring unit 130 may comprise an operating system (OS) under which programs and/or applications executed by CPU may run. According to embodiments of the invention and as shown by 450, monitoring unit 130 may comprise a memory on which executable code and associated parameters may be stored. Monitoring unit 130 may further comprise input devices 460. Such input devices may be a keyboard, a mouse or any other applicable input devices. Monitoring unit 130 may comprise output devices 470 that may be a display, speakers or any other applicable output devices. According to embodiments of the invention, input devices 460 and/or output devices 470 may also be devices such as a network interface card (NIC), a universal serial bus (USB) interface module or any other devices enabling monitoring unit 130 to communicate or interact with other computing devices and/or a human operating monitoring unit 130.

According to embodiments of the invention and as shown by 410, monitoring unit 130 may comprise a monitoring module. According to embodiments of the invention, module 410 may receive or otherwise obtain protocol packets. For example, RDP packets sent to unit 130 by modules 210 and/or 310 as described may be received by monitoring module 410. Alternatively, a network device such as a router on network 160 (not shown) may be configured to route or forward protocol packets to unit 130, such packets may be received by monitor module 410. For example, RDP packets exchanged between server 170 and computing device 120 may be forwarded by such router to monitoring unit 130 and thus obtained by monitoring module 410.

According to embodiments of the invention, module 410 may further analyze received protocol packets, extract data and/or information form such packets and compute various parameters based on information in such packets. As known in the art, protocols used for communicating display information may use various ways to improve performance and reduce network utilization. For example, RDP may use a technique whereby graphical display items, known as glyphs sent from a server to a client are associated with an identification code and are cached by the client. Accordingly, when a cached glyph is to be rendered on a remote client display the server may only send the relevant identification code to the client thus causing the glyph to be rendered on the client display. According to embodiments of the invention, monitor module 410 may cache information such as glyphs exchanged over a session established between a server and client such as server 170 and client 120. It will be understood that storing or caching glyphs as described may be one example of information, state, context or any applicable parameters monitor 410 may store for a session. For example, parameters pertaining to security aspects may also be stored by monitor module 410. For example, encryption keys or certificates exchanged between a server and client may be stored by monitor 410. For example, encrypted RDP sessions may rely on preinstalled certificates on both server and client. According to embodiments of the invention, module 210 may receive such keys or certificates from an application on server 170 and send such keys or certificates to monitor module 410, possibly via packet forwarding module 210.

According to embodiments of the invention and as shown by 480, monitoring unit 130 may comprise or be connected to a storage device. Storage device may be any applicable storage device such as a hard disk or storage chip. According to embodiments of the invention and as shown by 481, state information pertaining to a session may be stored by module 410 on storage device 480. Such state information may comprise cached glyphs or other display related information, security parameters such as encryption keys or certificates and other information. For example, information or parameters associating a session with specific computers or callers may also be stored in 481. For example, a computer telephony interface (CTI) application executing on server 170 or another computer may provide monitor module 410 with information associating a session with a phone number or other parameters. For example, such CTI application may be one of applications 230 and may communicate CTI information to module 410 via forwarding module 210. According to embodiments of the invention, any information that may be required in order to perform a usable recording and subsequent playback of a display session may be stored by monitor module 410 in state information 481.

According to embodiments of the invention, any relevant information that may be needed in order to perform a useful recording or playback of a display me be stored by module 410 in storage 480 as part of state information 481. For example, display settings such as resolution in pixels or any other applicable hardware or software settings that may be required in order to accurately replay rendering or other events and graphics of a recorded display. Other information stored may be any applicable background, settings, states, context or other applicable parameters such as dimensions, colors or locations of graphical objects on the display. According to embodiments of the invention, compression may be another aspect associated with a context or state computed and stored by module 410. For example, some compression schemes may require various parameters, keys, codes or other information in order to uncompress or decompress compressed information. Such information may be part of a context or state information module 410 may receive, derive, compute, obtain and/or store.

According to embodiments of the invention and as shown by 415, monitoring unit 130 may comprise one or more remote applications, for example, a remote assistance application. According to embodiments of the invention, such remote applications may be activated in order to cause a remote computing device to produce display information packets that may further be captured by monitor module 410. For example, activating a Windows© Remote Assistance application on unit 130 with computing device 120 as the target computer may cause computing device 120 to send RDP packets to unit 130. Such RDP packets may be captured by monitor module 410 and may further be used to derive and store state information as described above.

According to embodiments of the invention, context and/or state information pertaining to a display may be maintained by module 410 as described regardless of whether a recording of the display is in progress, namely, even at times when such recording is not performed nor planned. In environments such as call centers or other interaction related facilities, it may be desirable to start recording or streaming a display at a chosen time which may be other than the time when the session being streamed or recorded started or the time when the associated computing device or display was turned on. In such environments, start time and duration of a streaming or recording of a display may be selected according to various parameters, events, commands, conditions or circumstances.

For example, in a contact center, a recording or streaming of a display may be triggered according to parameters such as a caller ID, a specific campaign, a Dialed Number Identification Service (DNIS) parameter, an agent, an associated application or any other applicable parameters associated with an interaction of a customer with the contact center. Alternatively, a supervisor may wish to be provided, at any given time, with a real-time screen replay of an agent's display. According to embodiments of the invention, a supervisor may choose to be provided with such real-time replay at any point while the agent is interacting with a customer.

As described above, at the time a streaming or recording may be desirable, the associated computing device, e.g., device 120 may already have been active for some time. Accordingly, state or context information, e.g., cached glyphs and their associated identification codes may have already been exchanged, for example, between device 120 and server 170. Recording protocol packets exchanged between device 120 and server 170 at such point may be useless since some of the information exchanged may reference parameters exchanged at earlier stages. For example, references in such protocol packets may be made to cached glyphs. Accordingly, in order to produce a usable stream of display data or commence a useful, in-context streaming, recording or replay of a display at any arbitrary point in time, updated state information and/or context information such as maintained by module 410 may be required.

According to embodiments of the invention, prior to beginning a recording of a display state information may be provided to the recording system. For example, a user operating management computing device 131 may instruct recording server 140 to commence a recording of display 110 connected to computing device 120. Such instruction may be received by unit 130 and may cause unit 130 to send state information 481 to recording server 140. Such state information may be used by recording server 140 in order to produce a usable recording of display 110. For example, cached glyphs contained in state information 481 may be used in order to interpret RDP messages, encryption keys contained in state information 481 may be used to decrypt information received an so on.

Alternatively, a user operating computing device 131 may elect to be provided with a real-time replay of display 110. Accordingly, unit 130 may send state information 481 to computing device 131 where such information may be used to present a real-time replay of display 110. As described, without such state information, a replay of display 110 on a display connected to device 131 may be impossible to perform as some of the information contained in protocol packets that may be received may be useless or impossible to interpret.

According to embodiments of the invention, modules 210, 220, 310, 410 and 415 may be implemented by software. Alternatively, these modules may be implemented by hardware, firmware or a combination of software, firmware and hardware. It will be recognized that various modules and functionalities described above may be differently distributed over computing devices described. For example, monitoring module 410 may be comprised in screen recording server 140. According to some embodiments of the invention, screen recording server may comprise module 410 and storage 480. Accordingly, functionality described with reference to module 410 may be performed by server 140. Such configuration may render sending of state information 481 to server 140 unnecessary. Such configuration may require the ability to install software or other components on server 140.

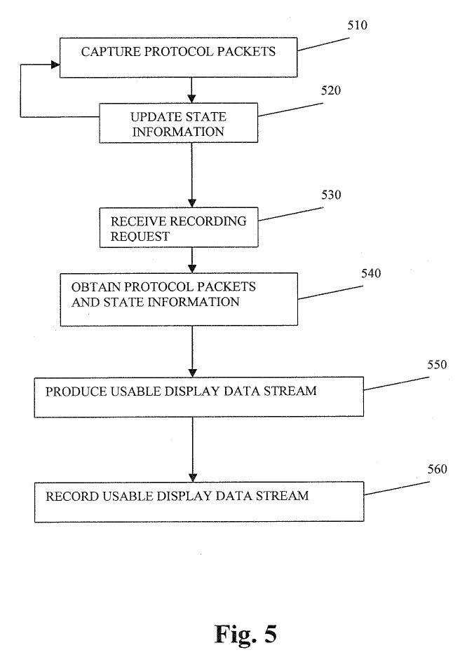

Reference is made to FIG. 5 showing an exemplary flowchart of a method of streaming and recording display data according to some embodiments of the invention. According to embodiments of the invention and as shown by block 510, the flow may include capturing protocol packets containing display information. For example, such protocol packets may be RDP packets. According to embodiments of the invention, such information may be any information, data or parameters required in order to compute, calculate, derive or otherwise obtain and maintain context and/or state information pertaining to a display.

According to embodiments of the invention, a module obtaining such information may selectively or otherwise capture display data stream, e.g., RDP packets or other protocol packets flowing between computing device 120 and server 170, for example if a virtual desktop scheme or architecture is implemented and/or used by computing device 120 and server 170. Alternatively, a software module may be integrated with an application that produces and/or consumes or utilizes display information. Such application may be a remote display application, remote desktop application or any application involved in sending and/or receiving display rendering data or other applicable display information, such application may execute on the computing device connected to the display being captured or it may be executing on an associated computing device, for example, a remote server.

Such application may be executing on the computing device associated with the display being captured or with any another computing device. For example, a module configured to obtain display data and/or information may be integrated with any applicable application on a remote application server, e.g., server 170. Such integration may enable such module to obtain any information, data, parameters and/or any other context or state information discussed above made available or otherwise obtained by the application with which such module is integrated. For example, any RDP packets obtained by such applications may also be made available to one or more modules configured to capture and/or analyze obtained information.

According to embodiments of the invention, obtaining display information, data or display streams may be performed by a module installed on a computing device that may not be directly associated with either the computing device connected to the relevant display, e.g., computing device 120 or an associated server, e.g., server 170. For example, a software, hardware, firmware or a combination thereof module may be installed on unit 130. According to embodiments of the invention, selected packets exchanged between computing device 120 and server 170 may be forwarded to unit 130, for example, by a router on network 160, where such packets may be obtained by such module.

Alternatively, network 160 may be configured such that traffic between computing device 120 and server 170 is routed via unit 130, such configuration may enable a module installed on unit 130 to obtain any display information. For example, a module installed on unit 130 may extract from traffic flowing between computing device 120 and server 170 RDP packets exchanged between server 170 and computing device 120. Such module may further use such extracted information to maintain context and/or state information described above.

According to embodiments of the invention, obtaining display information, data or display streams may be performed by activating an application on a computing device capable of communicating over a network with the computing device associated with the display to captured. For example, various remote assistance, remote management, remote configuration and the like applications may comprise a real-time replay of a remote display on a local display. According to embodiments of the invention, one or more such applications, e.g., one of remote applications 415, may be executed on a computing device where a module, e.g., module 410, configured to obtain and analyze display information is installed. For example, a remote assistance application executed on unit 130 and associated with computing device 120 may enable module 410 installed on unit 130 to obtain relevant information, for example, RDP or ICA packets exchanged between unit 130 and computing device 120.

According to embodiments of the invention and as shown by block 520, the flow may include calculating and/or computing a context and/or state pertaining to the monitored display. According to embodiments of the invention, possibly using minimal storage, any information that may be relevant or required in order to maintain a context, state or other applicable aspects of a display may be maintained and stored. For example, unit 130 may maintain a context or an updated state information of display 110 connected to computing device 120. Such context may comprise any information that may be required in order to produce a usable stream of display data or commence usable streaming or recording of display 110. According to embodiments of the invention, a display may be monitored and its context, or updated state information, may be maintained for any period of time.

According to embodiments of the invention, such context or state may further comprise any information, data and/or parameters that may be required in order to decrypt encrypted information. For example, for security and/or privacy reasons, some protocols may encrypt rendering information and/or events such as mouse movements, keyboard key presses or applications output, such encrypted information or data may be decrypted by, for example, decryption keys that may be obtained as part of maintaining the context or state discussed above. It will be recognized that embodiments of the invention are not limited by the method, algorithm or scheme used to encrypt information. For example, various protocols or applications may manipulate data before communicating it by encoding, scrambling, reordering or otherwise relocating of bits, bytes, words, sections or paragraphs comprising rendering or other information. Other examples may be data obfuscation or a changing of values of various elements comprising a content, for example according to a, possibly secret, pattern or key.

According to embodiments of the invention, any information, parameters, codes, keys or other applicable data required to decrypt, decipher, interpret, translate or otherwise convert or transform encrypted information into usable information or data may be maintained as part of a context or state associated with a monitored display. For example, context or state associated with display 110 may be maintained by unit 130 based on data obtained as described above.

According to embodiments of the invention, context information may further comprise information associating context information and/or a stream of display data with a computing device and or a user associated with such computing device. For example, context maintained module 410 installed on unit 130 may comprise information or parameters pertaining to computing device 120. Such parameters may be an internet protocol (IP) address of computing device 120 or any other information or parameters identifying, associated with, or related to computing device 120. For example, various operating system (OS) parameters or information, various hardware related information such as central processing unit (CPU) type, memory and storage capacity or parameters pertaining to display 110, e.g., screen resolution, screen refresh rate, graphic adapter information, color quality etc. According to embodiments of the invention, information pertaining to a user operating the relevant computing device may also be maintained, for example, user name or other identification, duration of login etc.

According to embodiments of the invention, information, data and or parameters associating a display, computing device and/or user with a context and/or display data stream may be obtained in various ways. For example, integration with a management server such as Microsoft™ Systems Management Server (SMS) may enable module 410, possibly via module 220 as described, to obtain information such as user login name, IP address and the like. Alternatively, a module installed on a remote applications server such as server 170 may be configured to obtain such information from such server. Alternatively or additionally, some of such information may be obtained directly from network packets obtained as described above. For example, an IP address may be obtained from network layer information of RDP packets extracted as described above. Other information, for example, user login information may be obtained from various other packets exchanged between computing devices such as computing device 120 and server 170. According to embodiments of the invention and as shown by the arrow connecting block 220 and block 210, the process of maintaining an updated context or state may be iterative, namely, the process of capturing protocol packets and updating a state according to information in such packets may be repeated any number of times. Accordingly, a computing device may be monitored for any period of time. During such monitoring, context and state may be updated, recalculated or otherwise maintained up to date.

According to embodiments of the invention and as shown by block 530, the flow may include receiving a request to perform a display recording. According to embodiments of the invention, various events, rules, policies, circumstances and/or conditions may trigger a recording and/or streaming of display information. For example, a policy in a contact center may dictate that sessions lasting more than a predefined period of time should be recorded. Such recording may include voice recording as well as recording the relevant agent's display. According to embodiments of the invention, a management computer, e.g., computing device 131, module or entity may detect that a call has exceeded a predefined period of time and may further instruct unit 130 and/or recording system 140 to commence a recording of the relevant display. Other events or conditions that may trigger commencing a recording or streaming of display information may be an agent's or supervisor's action, for example, according to various conditions or judgment, an agent or supervisor may trigger a recording of voice and display pertaining to an interaction of an gent and customer in a contact center.

According to embodiments of the invention, a command, event or instruction to commence a streaming, recording and/or real-time replay of a display may be detected or received by a module maintaining a state and context of the relevant display. For example, a supervisor in a contact center, operating computing device 131 may decide to view, in real-time, a replay of a specific agent's display, for example, display 110. According to embodiments of the invention, a command or event may be communicated to unit 130 where context information may be maintained as described above. Alternatively, the supervisor may decide to commence a recording of display 110, similarly, an event or other indication may be communicated to unit 130 informing it that a streaming of display information is to commence. According to embodiments of the invention, unit 130 may also be informed of the target or destination of the display information streaming, e.g., recording system 140 and/or computing device 131.

According to embodiments of the invention and as shown by block 540, the flow may include obtaining context information. As described above, context information may be required in order to correctly interpret a stream of display information. For example, in order to record information that may be used later for a replay, recording system 140 may require context or state information that may be used as described above. Accordingly, unit 130, possibly upon receiving an indication that a streaming of display information is to commence may communicate context information to recording system 140 and/or computing device 131. Such context information may comprise any information, data and/or parameters as described above.

According to embodiments of the invention and as shown by block 540, the flow may include obtaining a display data stream. For example, screen recording server 140 may obtain a stream of display data from computing device 120, for example, by having router on network 160 forward RDP packets originating at computing device 120 to recording system 140 as described above.

According to embodiments of the invention and as shown by block 550, the flow may include producing an in-context, usable display data stream. According to embodiments of the invention, a display data stream, possibly received or obtained at a random point in time, may be used in combination with context or state information to produce an employable, utilizable or otherwise usable display data stream. According to embodiments of the invention, a module or entity may use context information and a display data stream to produce a usable, in-context stream of display data. For example, recording server 140 may be provided with context information by unit 130 and with a display data stream, for example, by having a router route or forward a stream of display data from computing device 120 to recording server 140. Recording server 140 may use the context information in combination with the display data stream to produce a utilizable or otherwise usable, in-context display data stream.

According to embodiments of the invention, possibly after being alerted that such streaming is required, and possibly after communicating context information to recording system 140 as described above, unit 130 may cause display information to be forwarded or otherwise communicated to recording system 140, for example, by applying an appropriate configuration to a router on network 160.

According to embodiments of the invention and as shown by block 560, the display data stream may be recorded, for example, recording server 140 may record the display stream.

Some embodiments of the present invention may be implemented in software for execution by a processor-based system, for example, recording server 140. For example, embodiments of the invention may be implemented in code and may be stored on a storage medium having stored thereon instructions which can be used to program a system to perform the instructions. The storage medium may include, but is not limited to, any type of disk including floppy disks, optical disks, compact disk read-only memories (CD-ROMs), rewritable compact disk (CD-RW), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

Such system may include components such as, but not limited to, a plurality of central processing units (CPU) or any other suitable multi-purpose or specific processors or controllers, a plurality of input units, a plurality of output units, a plurality of memory units, and a plurality of storage units. Such system may additionally include other suitable hardware components and/or software components.

For example, recording server 140 may be or may comprise a processor-based system comprising a processor and code that may be stored on an attached storage medium and may execute and perform functions as described with reference to network packet forwarding module 310, monitoring module 410 and may further use updated state information and a display stream to generate a usable display stream as described herein.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method for streaming display data, the method comprising:
receiving a stream of display data associated with a display of a computational device, the stream containing state information;
during a first of time, extracting the state information from said stream to maintain updated state information pertaining to said display; and
during a second period of time, producing a usable stream of display data from the updated state information and a currently received stream of display data.

2. The method of claim 1, further comprising recording said usable stream.

3. The method of claim 1, further comprising utilizing said usable stream to provide real-time replay of said display.

4. The method of claim 1, wherein said updated state information comprises at least one of a decryption parameter, a decompression parameter, a security certificate and cached glyphs.

5. The method of claim 1, wherein said updated state information comprises remote desktop protocol (RDP) context information and wherein said stream of display data comprises remote desktop protocol (RDP) packets.

6. An article comprising a computer-storage medium having stored thereon instructions that, when executed by a processing platform, result in:
receiving a stream of display data associated with a display of a computational device, the stream containing state information;
during a first of time, extracting the state information from said stream to maintain updated state information pertaining to said display; and
during a second period of time, producing a usable stream of display data from the updated state information and a currently received stream of display data.

7. The article of claim 6, wherein the instructions when executed further result in recording said usable stream.

8. The article of claim 6, wherein the instructions when executed further result in utilizing said usable stream to provide real-time replay of said display.

9. The article of claim 6, wherein said updated state information comprises at least one of decryption parameter, a decompression parameter, a security certificate and cached glyphs.

10. The article of claim 6, wherein said updated state information comprises remote desktop protocol (RDP) context information and wherein said stream of display data comprises remote desktop protocol (RDP) packets.
